(19) United States
(12) Patent Application Publication
(10) Pub. No.: US 2016/0324294 A1
(43) Pub. Date: Nov. 10, 2016

(54) Cosmetic Container Having Retractable Nozzle

(71) Applicant: YONWOO CO., LTD, Incheon (KR)

(72) Inventors: You-Seob Kim, Incheon (KR); Sung-Hwan Kim, Incheon (KR); Seo-Hui Jung, Incheon (KR)

(21) Appl. No.: 15/111,728

(22) PCT Filed: Jan. 13, 2015
(86) PCT No.: PCT/KR2015/000319

§ 371 Date: Jul. 14, 2016

(30) Foreign Application Priority Data
Jan. 15, 2014 (KR) 10-2014-0004920

(51) Int. Cl. A45D 34/04; B05B 11/00; B05B 15/06

(52) U.S. Cl. CPC A45D 34/04; B05B 15/068; B05B 11/3023; B05B 11/3052

(57) ABSTRACT

Provided is a cosmetic container having retractable nozzle. The cosmetic container having retractable nozzle, when a button member is pressed, enables a guide protrusion of an outer nozzle to move along a guide groove of a guide member such that the outer nozzle moves forward while the height thereof does not change and is withdrawn through an inlet/outlet hole of a supporting body, and then enables a pumping operation of a pumping member so as to discharge content, thereby allowing the content to be easily applied to an exact position and preventing the contamination of the container.

### BACKGROUND OF THE INVENTION

The present invention disclosed herein relates to a cosmetic container having retractable nozzle, and more particularly, to a cosmetic container having retractable nozzle, which, when a button member is pressed, enables a guide protrusion of an outer nozzle to move along a guide groove of a guide member such that the outer nozzle moves forward while the height thereof does not change and is withdrawn through an inlet/outlet hole of a supporting body, and then enables a pumping operation of a pumping member so as to discharge content, thereby allowing the content to be easily applied to an exact position and preventing the contamination of the container.

Generally, a pumping-type container refers to an article having a structure wherein content is discharged to the outside through a pumping operation of a pumping member coupled to an upper portion of a container body, comprising a container body where content is contained, a pumping member which is coupled to an upper portion of the container body and makes an interior of the container body into a vacuous state, thereby pulling up the content by a pumping operation, and a button part which is placed at an upper portion of the pumping member and ascends/descends according to a user's pressurization, thereby delivering pressure to the pumping member.

However, a pump-type cosmetic container having the same structure as the above is disclosed in Korean Registered Utility Model No. 20-0225456. (Hereafter, it will be referred as ‘the registered utility model’)

The registered utility model forming a discharge hole (19) at one side of a button so as to discharge the content according to a pumping operation has a structure wherein the discharge hole (19) formed at a button (18) is moved upward and downward together, when the button moves upward and downward, and the position thereof is changed, thereby causing a problem that it is difficult to apply content exactly to the place a user wants.

Moreover, there is another problem that content flows down along an outer circumferential surface of the container in the process of content being discharged and thereby causes the container contaminated.

### SUMMARY OF THE INVENTION

The present invention is devised to solve such problems described in the above, and the objectives thereof are to provide a cosmetic container having retractable nozzle which, when a button member is pressed, enables a guide protrusion of an outer nozzle to move along a guide groove of a guide member such that the outer nozzle moves forward while the height thereof does not change and is withdrawn through an inlet/outlet hole of a supporting body, and then enables a pumping operation of a pumping member so as to discharge content, thereby allowing the content to be easily applied to an exact position and preventing the contamination of the container.

To solve problems above, a cosmetic container having retractable nozzle, according to first embodiments of the present invention, is characterized in including: an outer container; an inner container which is received in the outer container and contains content therein; a pumping member which is coupled to an upper portion of the inner container and discharges the content by a pumping operation; a nozzle fixing body which is placed at an upper portion of the pumping member and fixes a nozzle; an inner nozzle which is coupled to the nozzle fixing body and forms a passageway wherein content discharged from the pumping member moves; an outer nozzle which is coupled to the inner nozzle to be able to move forward or backward, forming a discharging hole formed thereof such that content moving through the inner nozzle is discharged to the outside; a button member which ascends/descends at an upper portion of the pumping member according to the presence/absence of a user's pressurization; a guide member which, coupled at an inner side of the pumping member, moves along with the ascent/descent of the button member and guides forward/backward movement of the outer nozzle; a pump pressurization member wherein a lower end thereof is coupled to the pumping member and an upper end thereof is coupled to the button member, thereby delivering the pressure, which is generated when the button member is pressurized, to the pumping member; and a support body which is coupled to an upper portion of the outer container, comprising an inlet/outlet hole wherein the outer nozzle goes in at a side thereof.

Furthermore, the container is characterized in that at a front surface of the guide member are formed a pair of guide pieces with a predetermined distance apart, forming a space where the outer nozzle moves, wherein at the pair of guide pieces is formed a pair of guide grooves such that the outer nozzle guides a forward/backward movement of the outer nozzle.

Furthermore, the container is characterized in that at both sides of the outer nozzle, a pair of guide protrusions are inserted into the pair of guide grooves and move along guide grooves.

Furthermore, the container is characterized in that the outer nozzle has a configuration wherein, when the button member is pressurized, the guide protrusions move along the guide grooves and thereby move forward in a state of the outer nozzle moving forward while the height thereof is not changed such that the outer nozzle is withdrawn through an inlet/outlet hole of a supporting body.

Furthermore, the container is characterized in that at a bottom surface of an upper end of the button member is formed a coupling protrusion which is coupled to the pump pressurization member.

Furthermore, the container is characterized in that the pump pressurization member, coupled to an upper portion of the pumping member, may include: a movement tube coupled to an upper portion of the pumping member and having a movement tube forming a space such that content discharged from the pumping member moves to the inner nozzle; and a coupling part extending upward from the movement tube to an upper portion and closely contacting to the inner nozzle such that an upper portion opened of the inner nozzle is closed, comprising a coupling groove such that the coupling protrusion is coupled.

Furthermore, the container is characterized in that a separation-preventing protrusion is formed at an inner circumferential surface such that the coupling protrusion is prevented from being separated from the coupling groove when the coupling protrusion ascends inside the coupling groove.

Furthermore, the container is characterized in that, in a process that, when pressurized, the button member independently descends as much as the coupling protrusion moves from an upper portion of the coupling groove to a lower portion thereof, the outer nozzle firstly moves forward by the guide member, and from the moment when the coupling protrusion finishes descending inside the coupling groove, the button member starts to pressurize the pumping pressurization member, thereby allowing content to be discharged through the outer nozzle by a pumping operation of the pumping member.

Furthermore, the container is characterized in that a housing is coupled to an upper portion of the inner container, thereby fixing the pumping member to the inner container, forming a coupling tube at a center of an inner side in order to make it possible to couple with the nozzle fixing body at inner center of the inner container.

Furthermore, the container is characterized in that at an inner circumferential surface is formed a protrusion which guides a perpendicular movement of the button member, forming an insertion hole where the protrusion is inserted.

Furthermore, the container is characterized in that at an inner side of the housing is formed an elastic body which is installed at a lower portion of the guide member and moves the guide member and the button member in an upward direction by elasticity thereof.

Furthermore, the container is characterized in that at a front surface part of the button member is formed a sliding groove where the outer nozzle moves such that the button member is not interfered by the outer nozzle while the button member is ascending/descending.

Furthermore, the container is characterized in that at an inner nozzle is formed a rotation-preventing protrusion which provides a directional nature when assembled with the outer nozzle and prevents the outer nozzle from being rotated, and at the outer nozzle is formed a rotation-preventing groove wherein the rotation-preventing protrusion is inserted.

Furthermore, the container is characterized in that while the button member is ascending, a space (S2) that the coupling part ascends inside the inner nozzle is configured to be bigger than a space (S1) where the movement tube ascends inside the nozzle fixing body, thereby allowing the content remaining at a fore-end of the outer nozzle to be absorbed.

Meanwhile, a cosmetic container having retractable nozzle according to second embodiments of the present invention comprises: an outer container; an inner container which is received in the outer container and contains content therein; a pumping member which is coupled to an upper portion of the inner container and discharges content by a pumping operation thereof; a pump-pressurizing member which is placed at an upper portion of the pumping member and delivers pressure to the pumping member according to pressurization of a button member, equipping a movement tube such that the content discharged through the pumping member moves; an inner nozzle which is placed at an upper portion of the pump-pressurizing member, forming a passageway wherein the content moving though the movement tube moves; an outer nozzle which is coupled to the inner nozzle to be able to move forward or backward, forming a discharging hole in order to discharge the content moving through the inner nozzle to the outside; a button member which ascends/descends at an upper portion of the pumping member according to the presence/absence of a user's pressurization and guides a forward/backward movement of the outer nozzle; and a support body which is coupled to an upper portion of the outer container, forming an inlet/outlet hole wherein the outer nozzle goes in at a side thereof.

Furthermore, the above container is characterized in that at a bottom surface of an upper portion of the button member are formed a pair of guide pieces with a predetermined distance apart, forming a space where the outer nozzle moves in order not to be interfered by the outer nozzle when the button member ascends/descends, and at the pair of guide pieces are formed a pair of guide grooves such that the outer nozzle guides a forward/backward movement of the outer nozzle.

Furthermore, the above container is characterized in that at a bottom surface of an upper portion of the button member are formed a multitude of pump-pressurizing protrusions which are secured to an upper end of the pump-pressurizing member and pressurize the pump-pressurizing member when the button member descends.

Furthermore, the above container is characterized in that the inner nozzle has a cylindrical shape such that the movement tube is penetrated into is configured to include: a body having a tubular shape such that the movement tube can be penetrated and ascends/descends; a connecting part which is extended to a side of the body and moves contents to the outer nozzle; and a securing plate encasing a part of the body and forming a multitude of inserting holes such that the pressurizing protrusion may be inserted.

Furthermore, the above container is characterized in that at an inner side of the support body is formed a support part which supports a lower end of a securing plate of the inner nozzle and fixes the inner nozzle.

As described as the above, according to the present invention, a cosmetic container having retractable nozzle, when a button member is pressed, enables a guide protrusion of an outer nozzle to move along a guide groove of a guide member such that the outer nozzle moves forward while the height thereof is not changed and is withdrawn through an inlet/outlet hole of a supporting body, and then enables a pumping operation of a pumping member so as to discharge content, such that the cosmetic container having retractable nozzle has advantages in that the content is easily applied to an exact area and the container is also prevented from being contaminated.

### BRIEF DESCRIPTION OF THE DRAWINGS

FIG. 1 is an exploded perspective view illustrating a configuration of cosmetic container having retractable nozzle according to a first exemplary embodiment of the present invention;

FIG. 2 is a combined perspective view illustrating a configuration of a cosmetic container having retractable nozzle according to a first exemplary embodiment of the present invention;

FIG. 3 is a cross-sectional view illustrating a configuration of a cosmetic container having retractable nozzle according to a first exemplary embodiment of the present invention;

FIG. 4 to FIG. 6 are explanatory views illustrating an operational state of a cosmetic container having retractable nozzle according to a first exemplary embodiment of the present invention;

FIG. 7 is an explanatory view illustrating an absorbing process of content remaining in a fore-end of an outer nozzle of a cosmetic container having retractable nozzle according to a first exemplary embodiment of the present invention;

FIG. 8 is an exploded perspective view illustrating a configuration of cosmetic container having retractable nozzle according to a second exemplary embodiment of the present invention;

FIG. 9 is a cross-sectional view illustrating a configuration of a cosmetic container having retractable nozzle according to a second exemplary embodiment of the present invention;

FIG. 10 is an explanatory view illustrating an operational state of a cosmetic container having retractable nozzle according to a first exemplary embodiment of the present invention;

FIG. 11 is a cross-sectional view illustrating a configuration of a cosmetic container having retractable nozzle according to a third exemplary embodiment of the present invention;

FIG. 12 is an explanatory view illustrating an absorbing process of content remaining in a fore-end of an outer nozzle of a cosmetic container having retractable nozzle according to a third exemplary embodiment of the present invention;

### DETAILED DESCRIPTION OF PREFERRED EMBODIMENTS

Hereinafter, exemplary embodiments of the present invention will be described in detail with reference to the accompanying drawings. The same reference numerals provided in the drawings indicate the same members.

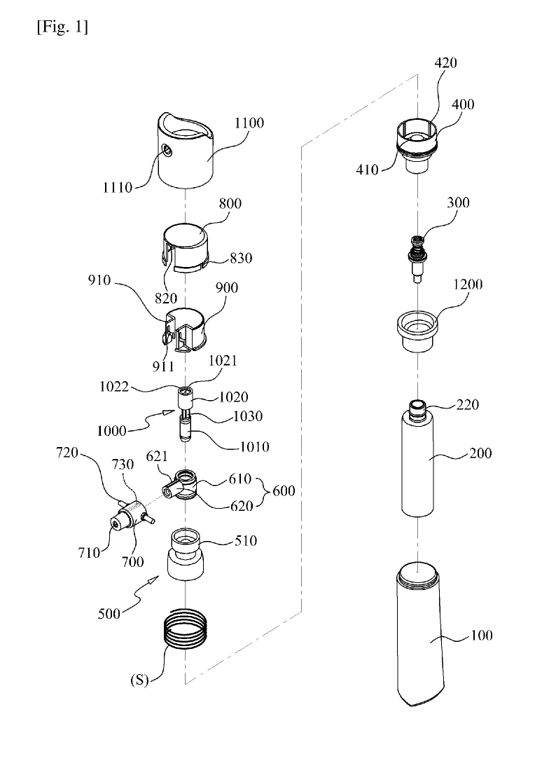

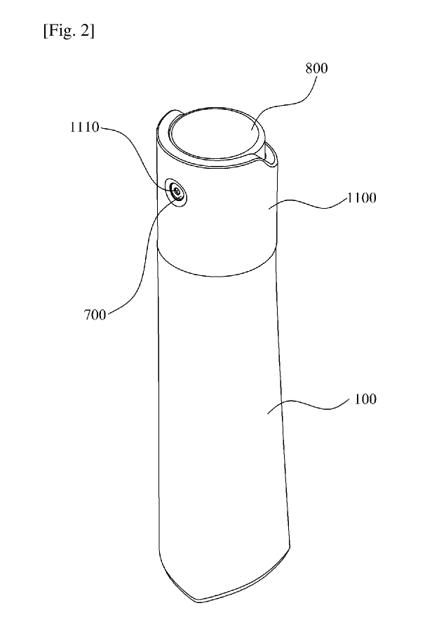

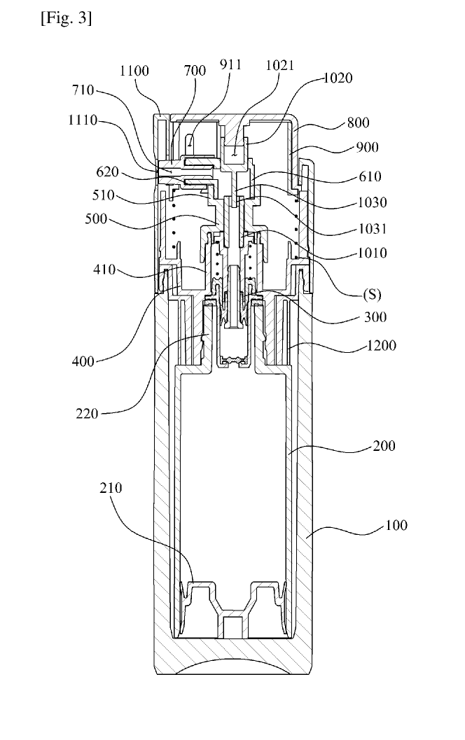

FIG. 1 is an exploded perspective view illustrating a configuration of cosmetic container having retractable nozzle according to a first exemplary embodiment of the present invention; FIG. 2 is a combined perspective view illustrating a configuration of a cosmetic container having retractable nozzle according to a first exemplary embodiment of the present invention; and FIG. 3 is a cross-sectional view illustrating a configuration of a cosmetic container having retractable nozzle according to a first exemplary embodiment of the present invention.

Referring to FIGS. 1 to 3, a cosmetic container having retractable nozzle according to an exemplary embodiment of the present invention may include an outer container 100, an inner container 200, a pumping member 300, a housing 400, a nozzle fixing body 500, an inner nozzle 600, an outer nozzle 700, a button member 800, a guide member 900, a pump pressurizing member 1000, and a support body 1100.

The outer container 100 receiving an inner container 200 to be described later is formed with an upper end opened such that an inner container 200 can be received, wherein at an opened upper portion is coupled a container fixing body 1200 which fixes a support body 1100 to be described later and an inner container 200.

The inner container 200 is received to the outer container 100 and contains content therein, wherein at a lower end of an inner side thereof is provided a piston 210 ascending according to use of contents and at an upper portion thereof is provided a discharging hole 220 discharging a stored content.

At an inner side of the discharging hole 220 is coupled a pumping member 300 which discharges the content stored in the inner container 200, and at an outer side is coupled a housing 400 which fixes the pumping member 300 to the inner container 200.

The pumping member 300 is coupled to a discharging hole 220 of the inner container 200, wherein a pumping operation arises by pressurization of a button member 800, thereby discharging stored content to the outside, and each element comprising the pumping member 300 belongs to prior art of the technological field of the present invention; therefore, detailed explanation is omitted.

The housing is coupled to a discharging hole 220 of the inner container 200 and fixes the pumping member 300 to the inner container 200, wherein at a center portion of an inner side thereof is formed a coupling tube 410 for being coupled with a nozzle fixing body 500 to be described later, and at an inner circumferential surface thereof is formed a protrusion 420 inserted to an inserting groove 830 of a button member 800 so as to guide a perpendicular movement of the button member 800.

Meanwhile, at an inner side of the housing 400 is equipped an elastic body (S) which is installed at a lower portion of the guide member 900 and moves the button member 800 and the guide member 900 to an upward direction by the elastic force thereof.

The nozzle fixing body 500 coupled to a coupling tube 410 of the housing 400 at an upper portion of the pumping member 300 comprises a securing part 510 such that an inner nozzle 600 is secured at an upper portion thereof.

The nozzle fixing body 500 supports and fixes a lower end of a body 610 of the inner nozzle 200, thereby making it possible that height of the inner nozzle 600 is unchanged when pressurizing a button member 800.

Meanwhile, the nozzle fixing body 500 comprises a hollow such that a pump pressurizing member 1000 can penetrate and then ascends/descends.

The inner nozzle 600 is coupled with the nozzle fixing body 500 and forms a passageway where the content discharged from the pumping member 300 moves, comprising a body 610 formed of cylindrical shape so as to be penetrated and ascended/descended, and an extending part 620 which extends to a side of the body 610 and moves the content to an outer nozzle 700, wherein at an upper end of the extending part 620 is formed a rotation-preventing protrusion 621 to a rotation preventing groove 730 so as to provide a direction and prevent a rotation of the outer nozzle 700 when assembling to the outer nozzle 700.

The outer nozzle 700 is coupled to the extending part 620 of the inner nozzle 600 capable of a forward/backward movement, comprising a discharging outlet 710 so as to discharge content moving through the inner nozzle 600 to the outside.

In the present invention, it is characterized that a pair of guide grooves 911 of the guide member 900 are formed at both of the outer nozzle 700, wherein the guide protrusion 720, when a button member 800 ascends/descends, moves along guide grooves 911 of the guide member 900, moving forward or backward. Since the inner nozzle 600 is in a state of being fixed by the nozzle fixing body 500, the guide protrusion 720 moves forward or backward, and guides to be inserted and drawn through an inlet/outlet hole of the support body 1100 in a state of height of the outer nozzle 700 being unchanged.

Meanwhile, a rotation-preventing groove 730 is formed at an upper end of an inner side of the outer nozzle 700 such that the rotation-preventing protrusion 621 may be inserted.

The button member 800 ascends/descends at an upper portion of the pumping member 300 by the presence or absence of a user's pressurization, and delivers pressure to a pump pressurizing member 1000, thereby allowing a pumping operation of the pumping member 300, wherein at a bottom surface of an upper end is formed a coupling protrusion 810 which is coupled to coupling groove 1021 of the pump pressurizing member 1000.

The present invention is characterized in that the coupling protrusion 810 is configured to ascend/descend inside the coupling groove 1021 of the pump pressurizing member 1000, wherein the button member 800 descends independently not in related with the pump pressurizing member 1000 while the coupling protrusion 810 is descending inside the coupling groove 1021 of the pump pressurizing member 1000, and thereby, the inner nozzle 700 is withdrawn to an inlet/outlet hole 1110 of the support body 1100 and a pumping operation of the pumping member 300 is achieved.

At a front of the button member 800 is preferred to be formed a sliding groove 820 where the outer nozzle moves, such that interference with the outer nozzle 700 does not arise while the button member 800 ascends/descends.

Meanwhile, at an outer circumferential surface of the button member 800 is inserted an inserting groove 830 where a protrusion 420 insert so as to move perpendicularly without inclining to either side.

The guide member 900 is coupled to an inner side of the button member 800, and moves along with the ascent/descent of the button member 800, and in the present invention, is characterized to guide the forward or backward movement of the outer nozzle 700 according to the ascent/descent of the guide member 900.

The guide member 900 has, at a front portion thereof, a pair of guide pieces 910 formed with a distance apart, forming a space where the outer nozzle 700 moves such that interfere with the outer nozzle 700 does not arise when the guide member 900 ascends/descends, wherein the pair of guide pieces 910 form a pair of guide grooves 911 where a pair of guide protrusions 720 are inserted respectively, capable of the forward movement and backward movement of the outer nozzle 700.

The guide groove 911 makes the outer nozzle 700 move forward when the guide member 900 is descended by pressurization of the button member 800, and makes the outer nozzle 900 move backward when the pressurization is released and the guide member 900 is ascended, thereby allowing the outer nozzle 700o be exposed to the outside only when content is discharged.

The pump pressurizing member 1000 is placed between the pumping member 300 and the button member 800 and delivers the pressure to the pumping member 300 when the button member 800 is pressurized, wherein a lower end thereof is coupled with the pumping member 300 whereas an upper end thereof is coupled with the button member 800, comprising: a movement tube 1010 which is coupled with an upper portion of the pumping member 300 and forming a space where the content discharged from the pumping member 300 may move into the inner nozzle 600; and a coupling part 1020 which extends from the movement tube 1010 to an upper portion, and comes to closely contact to an inner circumferential surface of the body 610 of the inner nozzle 600 so as to close a opened upper portion of the inner nozzle 600, further comprising a coupling groove 1021 for the coupling protrusion 810 to be coupled.

Between the movement tube 1010 and the coupling part 1020 is equipped a connector 1030 connecting the movement tube 1010 and the coupling part 1020, wherein the connector 1030 extends upward comprising a multitude of movement hole 1031 formed with a predetermined distance apart at an inner side of an upper portion of the movement tube 1010 such that content moving through the movement tube 1010 may move upward.

Meanwhile, at an inner circumferential surface of the coupling groove 1021 is equipped a separation preventing protrusion 1022 such that the coupling protrusion 810 is prevented from being separated from the coupling groove 1021 when ascending inside the coupling groove 1021.

The support body 1100 is coupled encasing the housing 400 at an upper portion of the outer container 100, comprising an inlet/outlet hole 1110 at a side thereof such that the outer nozzle 700 can go in and out.

The support body 1100 is preferred to be formed in a way that it is easy for a user to pressurize a button member 800.

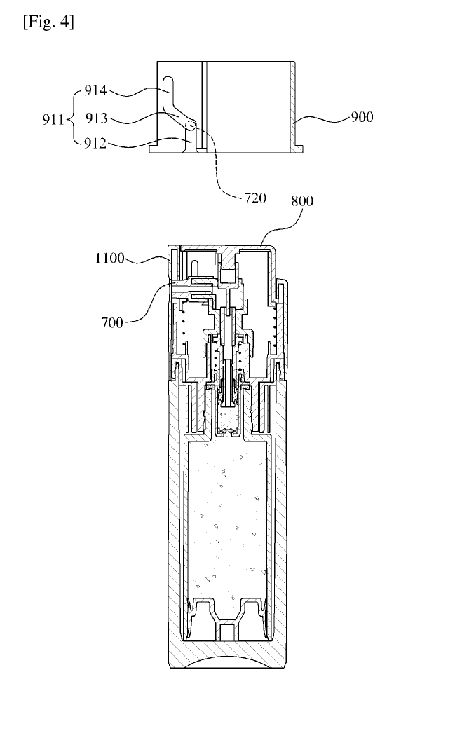

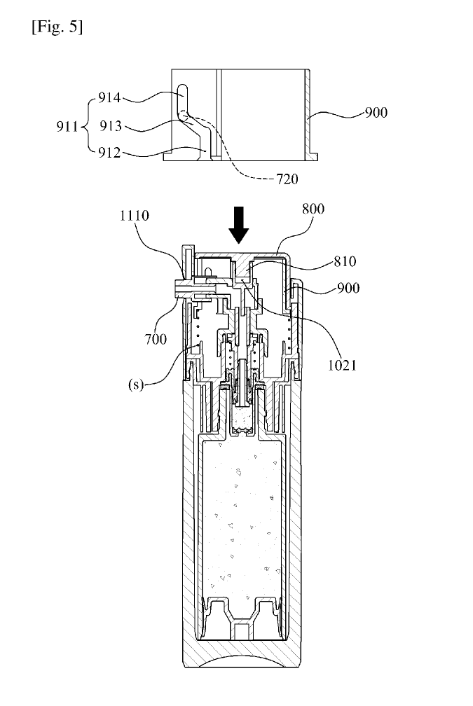

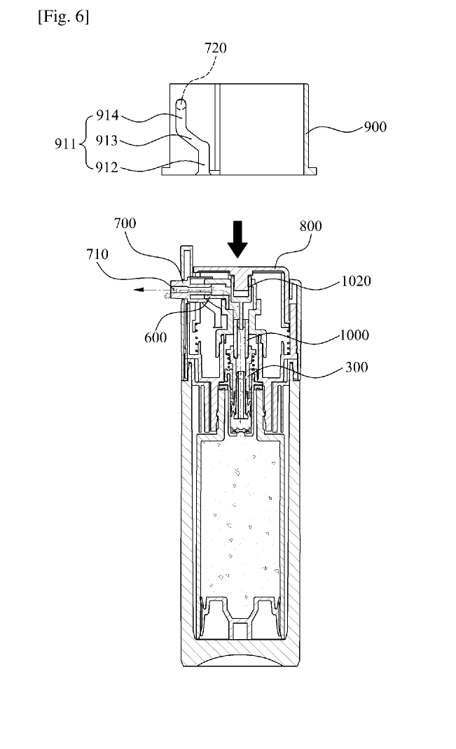

Hereinafter, an operational procedure of a cosmetic container having retractable nozzle according to a first exemplary embodiment of the present invention will be described with reference to FIGS. 4 to 7.

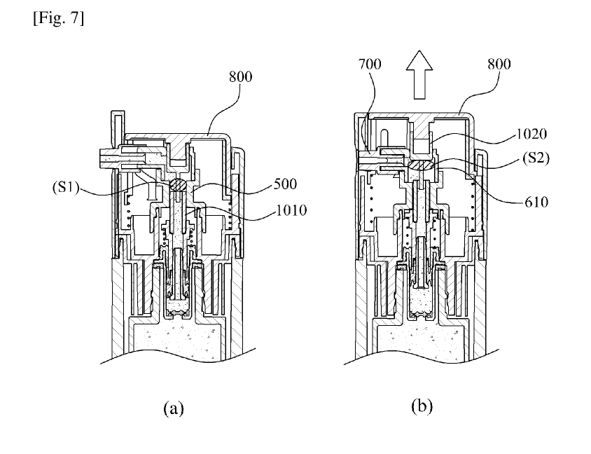

FIGS. 4 to 6 are explanatory views illustrating an operational state of a cosmetic container having retractable nozzle according to a first exemplary embodiment of the present invention, and FIG. 7 is an explanatory view illustrating an absorbing process of content remaining in a fore-end of an outer nozzle of a cosmetic container having retractable nozzle according to a first exemplary embodiment of the present invention.

Referring to FIGS. 4 to 6, a cosmetic container having retractable nozzle according to a first exemplary embodiment of the present invention, in an ordinary state when a button member 800 is ascended, has an outer nozzle 700 hidden at an inner side of the support body 1100, and at this time a guide protrusion 720 of the outer nozzle 700 is placed on a first perpendicular groove 912 of the guide groove 911 of the guide member 900

When the button member 800 is pressurized in this state, the button member 800 makes a separated descent independently, apart from the pump, by as much distance as a coupling protrusion 810 of a button member moves from an upper portion to a lower portion, and at this moment, a guide member 900 coupled at an inner side of the button member 800 makes a descent all together, thereby moving an outer nozzle 700 forward.

While the outer nozzle 700 is withdrawn through an inlet/outlet hole 1110 of the support body 1100 as a guide protrusion 720 goes forward moving along a slanting groove 913 of the guide groove 911 in a process of the guide member 900 descending.

Next, when continuously pressurizing the button member 800 in a state that the outer nozzle 700 is withdrawn through the an inlet/outlet hole 1110, the coupling protrusion 810 comes to pressurize the button member 800, the button member 800 pressurizes the pump pressurizing member 1000 from the moment when the coupling protrusion 810 finishes descending; thus, the pump pressurizing member 1000 descends and then pressurizes the pumping member 300, thereby making the content discharged through the outer nozzle 700 by a pumping operation of the pumping member 300. At this time, the guide protrusion 720 comes to be placed at an end of a second perpendicular groove 914 of the guide groove 911.

Next, when releasing pressurization of the button member 800, the button member 800 and the guide member 900 ascend by elasticity of a spring (S); at this time, the guide protrusion 720 of the outer nozzle 700 moves backward along a slanting groove 913 of the guide groove 911 and a first perpendicular groove 912, thereby being inserted into an inner side of the support body 1100.

Meanwhile, in a process that a button member 800 is ascended by restoration of the pumping member 300 and elasticity of a spring (S), as shown in FIG. 7, since the space (S1) where a coupling part 1020 ascends at an inner side of a body 610 of an inner nozzle 600 is wider than the space (S2) where a movement tube 1010 ascends at an inner side of a nozzle fixing body 500, it is possible to absorb content remaining in a fore-end of the outer nozzle 700, thereby preventing content from being leaked.

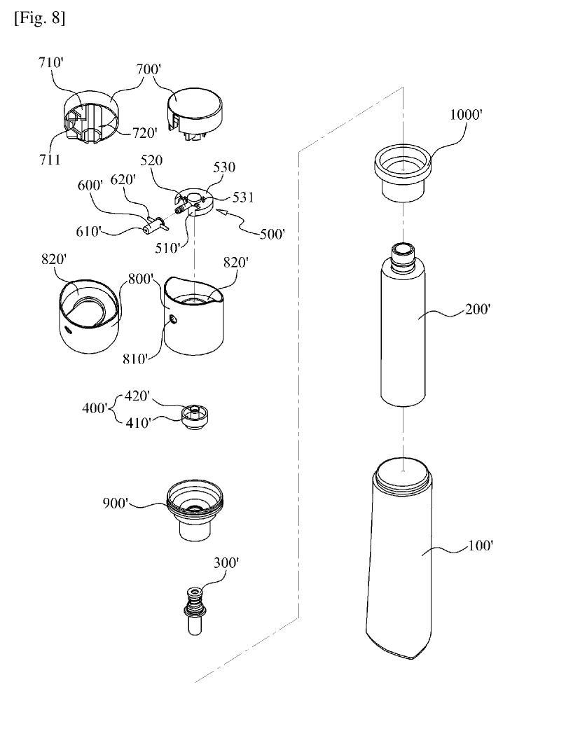

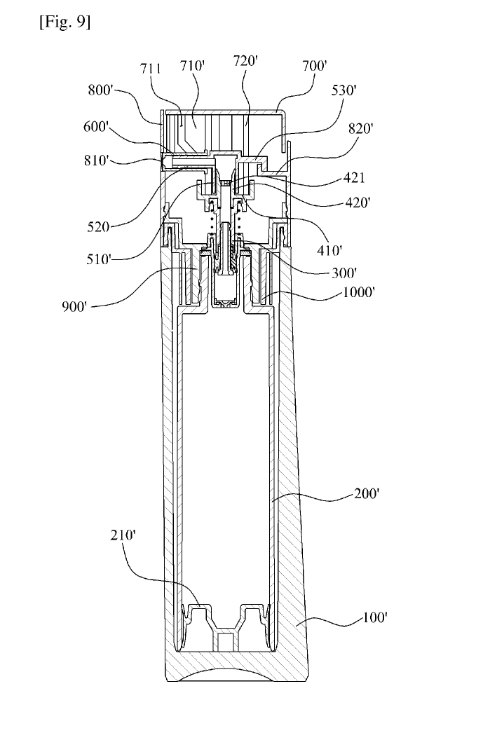

Hereinafter, a cosmetic container having retractable nozzle according to a second exemplary embodiment of the present invention will be described with reference to FIGS. 8 and 9.

FIG. 8 is an exploded perspective view illustrating a configuration of cosmetic container having retractable nozzle according to a second exemplary embodiment of the present invention; and FIG. 9 is a cross-sectional view illustrating a configuration of a cosmetic container having retractable nozzle according to a second exemplary embodiment of the present invention.

Referring to FIGS. 8 and 9, a cosmetic container having retractable nozzle according to a second exemplary embodiment of the present invention comprises an outer container 100′, an inner container 200′, a pumping member 300′, a pump pressurizing member 400′, an inner nozzle 500′, an outer nozzle 600′, a button member 700′ and a support body 800′.

Since the outer container 100′, the inner container 200′ and the pumping member 300′ have the same configuration and function as a first exemplary embodiment, detailed explanation is omitted.

The pump pressurizing member 400′ is placed at an upper portion of a pumping member 300′ and delivers pressure to the pumping member 300′ according to pressurization of a button member 700′, comprising a securing part 410′ where a pressurizing protrusion 720′ of the button member 700′ is secured, and a movement tube 420′ where content discharged from the pumping member 300′ moves.

The inner nozzle 500′ is secured to an upper end of a support part 820′ of a support body 800′ at an upper portion of the pump pressurizing member 400′ and forms a passageway where the content moving through the movement tube 420′ moves, comprising: a body 510′ in a cylindrical shape such that the movement tube 420′ can penetrates and ascends/descend; an extending part 520 which is extended to a side of the body 510′ and moves content to an outer nozzle 600′; and a securing plate 530 which encases a part of the body 510′ and forms a multitude of inserting holes 531 such that a pressurizing protrusion 720′ of a button member 700′ can be inserted, wherein the securing plate 530 is secured to a support part 820′ of a support body 810′, thereby making it possible for an outer nozzle to move with the height thereof unchanged when an outer nozzle 600′ moves forward or backward.

The outer nozzle 600′ is coupled to an extending part 520 of the inner nozzle 500′ so as to move forward or backward, comprising a discharging outlet 610′ where the content moving through the inner nozzle 500′ to the outside is discharged.

In the present invention, it is characterized that at both sides of the outer nozzle 600′ are formed a pair of guide protrusions 620′ which are inserted into a pair of guide grooves 711 of the button member 700′ and moves along the guide grooves 711, wherein the guide protrusion 620′ moves along a guide groove 711 formed at a guide piece 710′ when a button member 700′ ascends/descends, and moves an outer nozzle 600′ forward or backward. Since an inner nozzle 500′ is in a state of being secured by a support part 820′, the inner nozzle 500′ moves the outer nozzle 600′ forward or backward in a state of the height of the inner nozzle 500′ being unchanged and guides the inner nozzle 500′ to be inserted and withdrawn through an inlet/outlet hole 810′ of a support body 800′.

The button member 700′ ascends/descends at an upper portion according to the presence or absence of a user's pressurizing, and delivers pressure to a pump pressurizing member 400′, making a pumping operation of the pumping member 300′ possible, further comprising a multitude of pressurizing protrusions 720′ formed with a predetermined distance apart at a bottom surface of an upper end thereof so as to pressurize a pump pressurizing member 400′ when the button member 700′ descends.

In the present invention, the button member 700′ is characterized to ascend/descend according to the presence or absence of a user's pressurizing and guide the outer nozzle 600′ forward or backward.

At a bottom surface of an upper end of the button member 700′ is equipped a pair of guide pieces 710′ with a predetermined distance apart, forming a space where the outer nozzle 600′ moves so as to prevent interference with the outer nozzle 600′, wherein at the pair of guide pieces 710′ are equipped with a pair of guide grooves 711 where a pair of guide protrusions 620′ installed at both sides of the outer nozzle 600′ are inserted respectively so as to guide a forward or backward movement of the outer nozzle 600′.

The button member 700, when descending, moves the outer nozzle 600′ forward through the guide groove 711, and moves the outer nozzle 600′ backward when ascending, thereby making it possible to expose the outer nozzle 600′ to the outside only when content is being discharged.

The support body 800′ is coupled encasing the housing 900′ at an upper portion of the outer container 100, comprising an inlet/outlet hole 810′ such that the outer nozzle 600′ can go in and out at a side surface thereof.

The present invention′ is characterized in that, at an inner side of the support body 800 is equipped a support part 820′ which supports a lower end of a securing plate 530 of the inner nozzle 500′ and fixes an inner nozzle 500′, wherein the support part 820′, when the button member 700′ ascends/descends, supports and fixes a lower end of the securing plate 530 in order to make the height of the inner nozzle 500′ unchanged, thereby making it possible that the outer nozzle 600′ can be inserted and withdrawn through an inlet/outlet hole 810′.

Meanwhile, the support 800′ is preferred to be formed with a part of an upper end thereof cut and open so as to make it easy for a user to pressurize the button member 700′.

Meanwhile, at an inner side of the support body 800′ is coupled a housing 400′ which is coupled to a discharging hole 220′ of the inner container 200′ and fixes the pumping member 300′ to the inner container 200′, comprising a hollow at the housing 400′ such that the pumping member 300′ can be penetrated and installed.

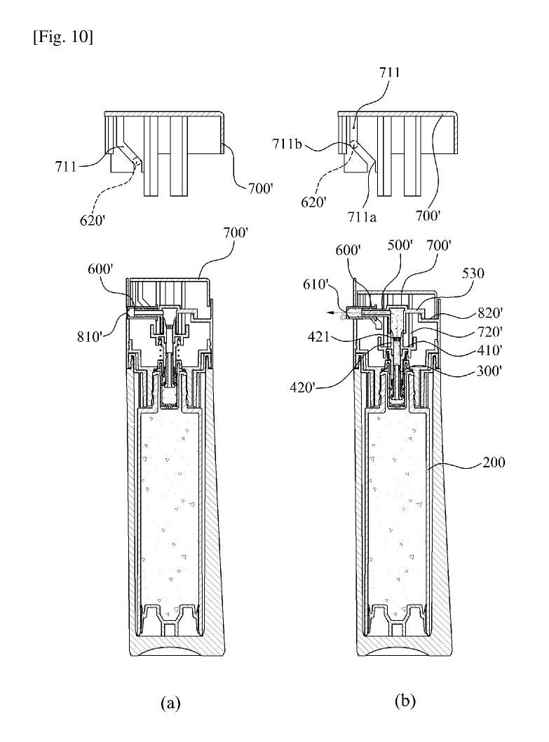

Hereafter, an operation procedure of a cosmetic container having retractable nozzle according to a second exemplary embodiment of the present invention will be described with reference to FIG. 10. FIG. 10 is an explanatory view illustrating an operation procedure of a cosmetic container having retractable nozzle according to a second exemplary embodiment of the present invention.

Referring FIG. 10, a cosmetic container having retractable nozzle according to a second exemplary embodiment of the present invention;

wherein ordinarily in a state of a button member 700′ ascending, an outer nozzle 600′ is placed hidden at an inner side of a support body 800′, and at this time a guide protrusion 620′ of the outer nozzle 600′ is placed at a fore-end of slanting groove 711a of a guide groove 711.

When a button member 700′ is pressurized in this state, a guide protrusion 620′ of the outer nozzle 600′ moves forward to an end point of a slanting groove 711b of a guide groove 711 formed at a guide piece of the button member 700′, thereby allowing the outer nozzle 600 to be withdrawn through an inlet/outlet hole 1110 of the support body 700′; at the same time, as a pressurizing protrusion of the button member 700′ pressurizes a pump pressurizing member 400′, and thus pressurizing the pumping member 300′, the pump pressurizing member 400 is descending and pressurizing the pumping member 300′, thereby leading the to be discharged through the outer nozzle 600′ by a pumping operation of the pumping member 300′.

Next, when pressurization of the button member is released, the pumping member 300 is restored and thereby the button member 700′ ascends; at this time, a guide protrusion 620′ of the outer nozzle 600′ moves backward from a end-point of slanting groove 711b to a fore-end of slanting groove 711a, thereby allowing the outer nozzle 600′ to be inserted to an inner side of the support body 1100.

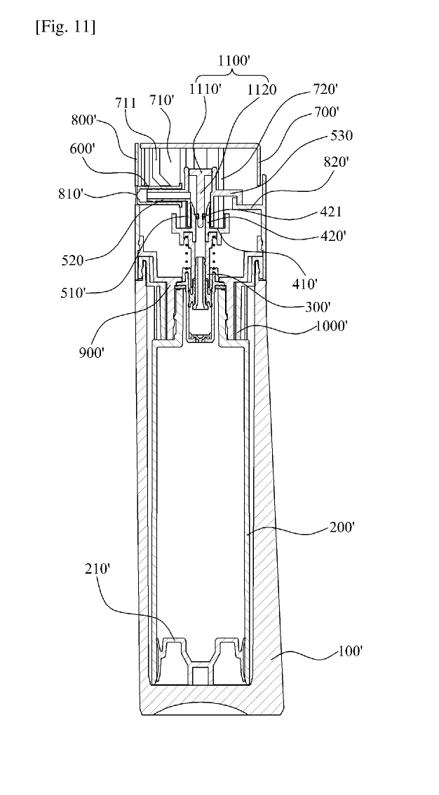

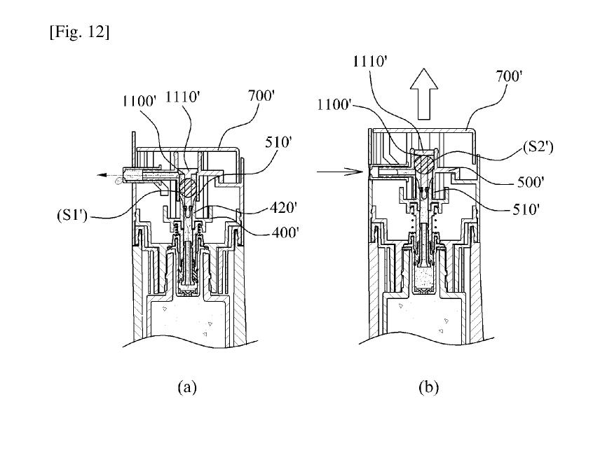

Meanwhile, as shown in FIGS. 11 and 12, a cosmetic container having retractable nozzle according to a third exemplary embodiment of the present invention is configured to have an upper end of a body 510′ of the inner nozzle 500′ opened, comprising an ascending and descending member 1100′ which closes an opened upper end portion of the body 510′ and is coupled so as to ascend and descend inside of the body 510′.

The ascending and descending member 1100′, comprising a sealing tube 1110′ tightly contacted to an inner circumferential surface of the body 510′ and a coupling bar 1120 coupled to a coupling protrusion 421 equipped at an inner side of a movement tube 420′ of a pumping pressurizing member 400′, is configured to move along with ascent/descent of the button member 700′, wherein in a process of the button member 700′ ascended by restoration of the pumping member 300, as shown in FIG. 12, the space (S2) where a sealing tube 1110′ of an ascending and descending member 1100′ ascends at an upper inner side of a body 510′ of an inner nozzle 600′ is wider than the space (S2) where a movement tube 420′ ascends at a lower inner side of a body 510′ of the inner nozzle 500′, such that it is possible to absorb the content remaining in a fore-end of the outer nozzle 600′, thereby preventing the content from being leaked.

Detailed explanations of the rest structures are omitted because they are the same with a second exemplary embodiment of the present invention.

As described above, optimal embodiments have been disclosed in the drawings and the specification. Although specific terms have been used herein, these are only intended to describe the present invention and are not intended to limit the meanings of the terms or to restrict the scope of the present invention as disclosed in the accompanying claims. Therefore, those skilled in the art will appreciate that various modifications and other equivalent embodiments are possible from the above embodiments. Therefore, the scope of the present invention should be defined by the technical spirit of the accompanying claims.

What is claimed is:

1. A cosmetic container having a retractable nozzle comprising:
an inner container (200) containing content;
a pumping member (300) coupled to an upper portion of the inner container and discharging content by a pumping operation;
a nozzle fixing body (500) placed at an upper portion of the pumping member and fixing a nozzle;
an inner nozzle (600) coupled to the nozzle fixing body (500) and forming a passageway where content discharged from the pumping member (300) moves;
an outer nozzle (700) coupled to the inner nozzle (600) to be able to move forward or backward and forming a discharging hole (220) such that content moving through the inner nozzle (600) is discharged to the outside;
a button member (800) ascending/descending at an upper portion of the pumping member (300) according to the presence or absence of a user's pressurizing;
a guide member (900) coupled at an inner side of the pumping member (300), moving along with the ascent or descent of the button member (500) and thereby guiding a forward or backward movement of the outer nozzle (700);
a pump pressurization member (1000) wherein a lower end thereof is coupled to the pumping member (300) and an upper end thereof is coupled to the button member (700), thereby delivering the pressure to the pumping member (300) when the button member (700) is pressurized; and
a support body (1100) comprising an inlet/outlet hole at a side thereof such that the outer nozzle (700) may go in and out.

2. The cosmetic container having retractable nozzle of claim 1,
wherein the guide member (900) has, at a front portion thereof, a pair of guide pieces (910) formed with a predetermined distance apart, comprising a space where the outer nozzle (700) moves such that an interference with the outer nozzle (700) does not arise when the guide member (900) ascends or descends,
wherein at the pair of guide pieces (910) are formed a pair of guide grooves (911) for guiding a forward or backward movement of the outer nozzle (700).

3. The cosmetic container having retractable nozzle of claim 2,
wherein at both sides of the outer nozzle (700) are provided a pair of guide protrusions (720) inserted to a pair of guide grooves and moving along the guide grooves (911).

4. The cosmetic container having retractable nozzle of claim 3,
wherein the outer nozzle (700) has a configuration in that the guide protrusion (720) moves along the guide groove (911) when the button member (900) is pressurized and moves forward in a state of the height thereof unchanged, thereby being withdrawn through an inlet/outlet hole (1110) of a supporting body (1100).

5. The cosmetic container having retractable nozzle of claim 1,
wherein at a bottom surface of an upper end of the button member (700) is provided a coupling protrusion (810) coupled to the pump pressurizing member (1000).

6. The cosmetic container having retractable nozzle of claim 5, the container comprising:
the pump pressurizing member (1000) further comprising:
a movement tube (1010) coupled to an upper portion of a pumping member (300) and forming a space such that content discharged from the pumping member (300) moves to the inner nozzle (600); and
a coupling part (1020) extended from the movement tube (1010) to an upper portion thereof, and closely contacted to the inner nozzle (600) so as to close an opened upper portion thereof, further comprising a coupling groove (1021) wherein the coupling protrusion (810) is coupled.

7. The cosmetic container having retractable nozzle of claim 6,
wherein a separation-preventing protrusion (1022) is provided at the coupling groove (1021) so as to prevent the coupling protrusion (810) from being separated from a coupling groove (1021) when ascending in the coupling groove (1021).

8. The cosmetic container having retractable nozzle of claim 7,
Wherein, when the button member (800) is pressurized in a process that the button member (800) independently moves downward by as much distance as the coupling protrusion (1022) moves from a upper portion of the coupling groove (1021) to a lower portion thereof, the outer nozzle (700) firstly moves forward by the guide member (900), and then the button member (700) pressurizes the pump pressurizing member (1000) from the moment that the coupling protrusion (1022) finishes descending inside the coupling groove (1021), thereby allowing content to be discharged through the outer nozzle (700) by a pumping operation of the pumping member (300).

9. The cosmetic container having retractable nozzle of claim 1, the container comprising:
a housing (400) coupled to an upper portion of the inner container (200) and fixing the pumping member (300) to the inner container (200), further comprising a coupling tube (410) so as to be coupled with the nozzle fixing body (500) at an inner center portion thereof.

10. The cosmetic container having retractable nozzle of claim 9, the container comprising:
a protrusion (420) guiding a perpendicular movement of the button member (800) at an inner circumferential surface of the housing (400); and
an inserting groove (830) wherein the protrusion (420) is inserted at an outer circumferential surface of the button member (800).

11. The cosmetic container having retractable nozzle of claim 9, the container comprising:
an elastic body (S) installed at a lower portion of the guide member (900) at an inner side of the housing (400) and moving the guide member (900) and the button member (800) to an upper direction by an elastic force thereof.

12. The cosmetic container having retractable nozzle of claim 1, the container comprising:
a sliding groove (820) wherein the outer nozzle (700) moves not to cause interference with the outer nozzle (700) when the button member (800) ascends/descends at a front surface of the button member (800).

13. The cosmetic container having retractable nozzle of claim 1,
wherein a rotation-preventing protrusion (621) is equipped at the inner nozzle (600) so as to provide a directional nature when assembled with the outer nozzle (700) and thus prevent a rotation of the outer nozzle (700),
wherein a rotation-preventing groove (730) is equipped at the outer nozzle (700) so as for the rotation-preventing protrusion (621) to be inserted.

14. The cosmetic container having retractable nozzle of claim 1,
wherein, in a process of the button member ascending, a space (S2) wherein the coupling part (1020) ascends at an inner side of the inner nozzle (600) is configured to be wider than a space (S1) where the movement tube (1010) ascends at an inner side of the nozzle fixing body (500) such that content remaining in a fore-end of the outer nozzle (700) can be absorbed.

15. The cosmetic container having retractable nozzle comprising:
an inner container (200′) containing content;
a pumping member (300′) coupled to an upper portion of the inner container (200′) and discharging content by a pumping operation;
a pump pressurizing body (400′) placed at an upper portion of the pumping member (300′) and delivers pressure to the pumping member (300′) according to pressurization of a button member (700′), further comprising a movement tube (420′) discharging content discharged through the pumping member (300′);
an inner nozzle (500′) placed at an inner portion of the pump pressurizing body (400′), forming a passageway for content moving through the movement tube (420′) to move;
an outer nozzle (700′) coupled to the inner nozzle (500′) to be able to move forward or backward, comprising a discharging outlet (610′) such that content moving through the inner nozzle (500′) is discharged to the outside;
a button member (800′) ascending/descending at an upper portion of the pumping member (300′) according to the presence or absence of a user's pressurizing; and
a support body (800′) comprising an inlet/outlet hole (1110) at a side thereof such that the outer nozzle (600′) may go in and out.

16. The cosmetic container having retractable nozzle of claim 15,
wherein at a bottom surface of an upper end of the button member (700′) is provided a pair of guide pieces (710′) with a predetermined distance apart, as forming a space, such that an interference with the outer nozzle (600′) may not arise when a button member (700′) ascends/descends,
wherein at the pair of guide pieces (710′) is provided a pair of guide grooves (911) so as to guide a forward or backward movement of the outer nozzle (600′).

17. The cosmetic container having retractable nozzle of claim 15,
wherein at a bottom surface of an upper end of the button member (700′) is provided a multitude of pressurizing protrusions (720′) with a predetermined distance apart such that the pressurizing protrusions (720′) may be secured at an upper end of the pump pressurizing member (400′) and pressurize the pump pressurizing member (400′).

18. The cosmetic container having retractable nozzle of claim 17,
wherein the inner nozzle (500′) comprises a body (510′) having a cylindrical shape such that the movement tube (420′) can be penetrated and ascend/descend therein; an extending part (520) extended to a side of the body (500′) and thereby moving content to the outer nozzle (600′); and a securing plate (530) encasing a part of the body (500′), further comprising a multitude of inserting holes (531) such that the pressurizing protrusion (720′) can be inserted.

19. The cosmetic container having retractable nozzle of claim 18,
wherein at an inner side of the support body (1100) is provided a support body (820′) supporting a lower end of the securing plate (530) of the inner nozzle (500′) and fixing the inner nozzle (500′).
